(19) United States
(12) Patent Application Publication
(10) Pub. No.: US 2013/0033237 A1
(43) Pub. Date: Feb. 7, 2013

(54) POWER GENERATION CONTROL SYSTEM FOR VEHICLE

(71) Applicants: Daekwang KIM, Hwaseong-si (KR); Minyoung Jung, Hwaseong-si (KR); Junyong Lee, Hwaseong-si (KR); Chikung Ahn, Hwaseong-si (KR)

(72) Inventors: Daekwang KIM, Hwaseong-si (KR); Minyoung Jung, Hwaseong-si (KR); Junyong Lee, Hwaseong-si (KR); Chikung Ahn, Hwaseong-si (KR)

(73) Assignee: HYUNDAI MOTOR COMPANY, Seoul (KR)

(21) Appl. No.: 13/301,338

(22) Filed: Nov. 21, 2011

(30) Foreign Application Priority Data
Aug. 5, 2011 (KR) 10-2011-0078060

(51) Int. Cl. H02P 9/48

(52) U.S. Cl. 322/25

(57) ABSTRACT

A power generation control system for a vehicle may include a battery supplying power to an electric load, a power generator supplying power to the battery and the electric load, and an electronic control unit (ECU) controlling the power generator in real time, based on driving information inputted from outside, battery information inputted from outside, and an efficiency map of the power generator, which may be predetermined by an efficiency map of an engine and built in the power generator.

### CROSS-REFERENCE TO RELATED APPLICATIONS

The present application claims priority to Korean Patent Application Number 10-2011-0078060 filed Aug. 5, 2011, the entire contents of which application is incorporated herein for all purposes by this reference.

### BACKGROUND OF THE INVENTION

1. Field of the Invention

The present invention relates to a power generation control system for a vehicle, and more particularly, to a power generation control system for a vehicle, which controls a power generator according to the state of a battery or the driving state of a vehicle.

2. Description of Related Art

A power generation control system applied to a vehicle is one of techniques for improving fuel efficiency. In the power generation control system, an electronic control unit (ECU) controls the drive of a power generator using battery information and driving information.

A power generation control system according to the related art does not reflect an aspect that fuel consumption based on a power generator load differs depending on power generation efficiency and engine efficiency, and sets a target voltage by considering only a state of charge (SOC) of a battery and a driving pattern. Therefore, the power generation control system has a limit to maximizing a fuel efficiency improvement effect.

The power generation control system according to the related art performs a uniform open loop control during a stage decided by the set target voltage. Therefore, the power generation control system has difficulties in immediately dealing with an environmental change.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to provide a power generation system for a vehicle, which controls a power generator by reflecting power generation efficiency and engine efficiency as well as an SOC of a battery and a driving pattern, thereby maximizing fuel efficiency improvement.

In an aspect of the present invention, the power generation control system for a vehicle, may include a battery supplying power to an electric load, a power generator supplying power to the battery and the electric load, and an electronic control unit (ECU) controlling the power generator in real time, based on driving information inputted from outside, battery information inputted from outside, and an efficiency map of the power generator, which is predetermined by an efficiency map of an engine and built in the power generator.

The ECU may include a minimum generation control module controlling the power generator to perform predetermined minimum generation under performance conditions in which a state-of-charge (SOC) value of the battery information is larger than a first reference value and satisfies a first logical expression, where the first logical expression is expressed as (V=0) or (V>a and APS<b and release of direction connection of engine and transmission), the V represents a vehicle velocity of the driving information, the APS represents an accelerator position value of the driving information, and the a and b represent constants, and a prohibition control module controlling the power generator to prohibit power generation, when the SOC value is larger than a predetermined first prohibition value even though the performance conditions of the minimum generation control module is satisfied.

The minimum generation control module is executed by setting a target voltage value for minimum generation of the power generator, using a current value, a voltage value, and a temperature value of the battery in the battery information, wherein the minimum generation control module is executed by setting the target voltage value for the minimum generation of the power generator using the temperature value of the battery in the battery information and then changing the target voltage value using the current value and the voltage value of the battery in the battery information, wherein the prohibition control module is executed by setting a target voltage value for prohibition of the power generation of the power generator using the temperature value of the battery in the battery information.

The ECU may include a prohibition control module controlling the power generator to prohibit power generation under performance conditions in which the SOC value of the battery information is larger than a first reference value and satisfies a second logical expression, where the second logical expression is expressed as (V>0) or {(ΔV>c) or (ΔAPS>d)}, the V represents a vehicle velocity, the ΔV represents a variable value of the vehicle velocity, the ΔAPS represents a variable value of an accelerator position value of the driving information, and the c and d represent constants, wherein the prohibition control module is executed by setting a target voltage value for prohibition of the power generation of the power generator using a temperature value of the battery in the battery information.

The ECU may include a maximum efficiency control module controlling the power generator such that an efficiency of the power generator is maintained within a maximum generation efficiency region of the efficiency map of the power generator, under performance conditions in which an SOC value of the battery information is larger than a first reference value and satisfies a third logical expression, where the third logical expression is expressed as (V>0) or {(e<ΔV<f) or (g<ΔAPS<h)}, the V represents a vehicle velocity, the ΔV represents a variable value of the vehicle velocity, the ΔAPS represents a variable value of an accelerator position value of the driving information, and the e, f, g, and h represent constants, and a prohibition control module controlling the power generator to prohibit power generation, when the SOC value is smaller than a predetermined second prohibition value even though the performance condition of the maximum efficiency control module is satisfied, wherein the maximum efficiency control module is executed by setting a target voltage value for a maximum efficiency of the power generator using an intake air flow rate and a revolution number of an engine in the vehicle information and a battery temperature value of the battery information, wherein the maximum efficiency control module is executed by setting the target voltage value for the maximum efficiency of the power generator using the intake air flow rate and the revolution number of the engine in the vehicle information and then changing the target voltage value using the battery temperature value of the battery information, wherein the prohibition control module is executed by setting a target voltage value for prevention of the power generation of the power generator using a battery temperature value of the battery information.

The ECU may include a maximum generation control module controlling the power generator to perform a maximum generation, under performance conditions in which an SOC value of the battery information is larger than a first reference value and satisfies a fourth logical expression, where the fourth logical expression is expressed as (V>a) and {(APS<b and direct connection of an engine and a transmission) or (fuel cut)}, the V represents a vehicle velocity of the driving information, the APS represents an accelerator position value of the driving information, and the a and b represent constants, wherein the maximum generation control module is executed by setting a target voltage value for the maximum generation of the power generator using a battery temperature value of the battery information.

The ECU may include a maximum efficiency control module controlling the power generator such that an efficiency of the power generator is maintained in a maximum generation efficiency region of the efficiency map of the power generator, under a performance condition in which an SOC value of the battery information is smaller than a first reference value and larger than a second reference value, and a fixed voltage control module controlling the power generator to maintain a predetermined fixed voltage, when the SOC value is smaller than the first reference value and is not larger than the second reference value, wherein the maximum efficiency control module is executed by setting a target voltage value for the maximum efficiency of the power generator using an intake air flow rate and a revolution number of the engine in the vehicle information and a battery temperature value of the battery information, wherein the maximum efficiency control module is executed by setting the target voltage value for the maximum efficiency of the power generator using the intake air flow rate and the revolution number of the engine in the vehicle information and then changing the target voltage value using a battery temperature value of the battery information.

The ECU may include a fixed voltage control module controlling the power generator to maintain a predetermined fixed voltage, when determining that there is an error in sensors of the power generator and the battery, using the vehicle information and the battery information, wherein the fixed voltage control module is executed by setting the fixed voltage using the battery temperature value of the battery information.

The ECU may include a ramping control module performing ramping control to smoothly change a voltage, in order to prevent a target voltage value from being rapidly changed when the target voltage value for controlling the power generator is changed.

According to the exemplary embodiments of the present invention, the power generation control system performs the power generation control in various modes by performing the maximum efficiency control considering the power generation efficiency and monitoring the vehicle information and the battery information provided from outside in real time. Therefore, it is possible to increase the fuel efficiency more than in the related art.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a block diagram of a power generation control system for a vehicle according to an exemplary embodiment of the present invention.

FIG. 2 is a function block diagram of an ECU according to the exemplary embodiment of the present invention.

FIG. 3 is a control flow chart of the power generation control system for a vehicle according to the exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Hereinafter, a power generation control system for a vehicle according to an exemplary embodiment of the present invention will be described with reference to the accompanying drawings.

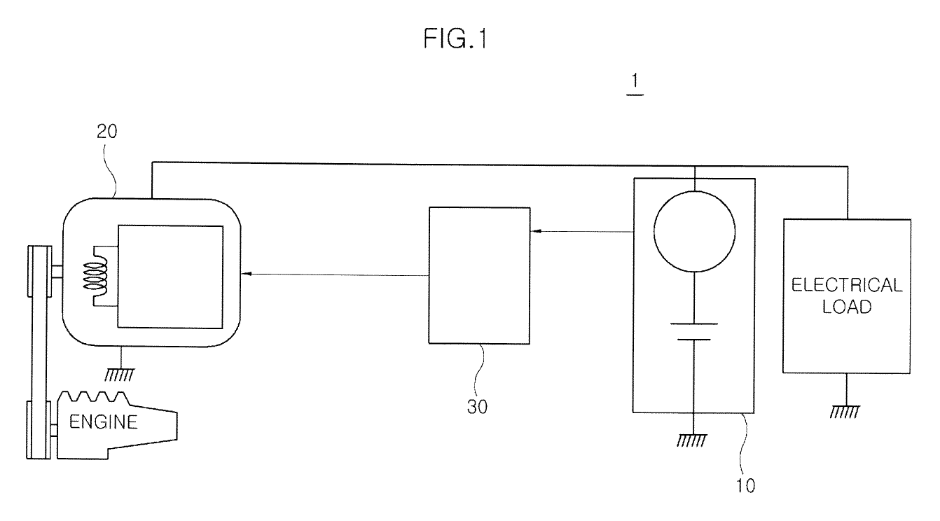

Referring to FIG. 1, power generation control system 1 for a vehicle according to the exemplary embodiment of the present invention includes a battery 10, a power generator 20, and an electronic control unit (ECU) 30. ECU 30 performs the overall control of the vehicle.

Power generation control system 1 for a vehicle may control power generator 20 in real time, based on driving information inputted from outside, battery information inputted from outside, and an efficiency map of the power generator, which is previously calculated by an efficiency map of an engine and built in the power generator.

The efficiency map of the power generator has a similar characteristic to the efficiency map of the engine. In this embodiment of the present invention, it is assumed that the efficiency of the power generator is proportional to the efficiency of the engine, in order to simplify expressions and facilitate control. Accordingly, power generation control system 1 for a vehicle according to the exemplary embodiment of the present invention may perform optimal control for the power generator in consideration of the engine efficiency.

As shown in FIG. 1, battery 10 is connected to power generator 20 and various electronic devices of the vehicle. Battery 10 receives power from power generator 20, stores the received power, and provides power to electrical loads corresponding to various electronic devices according to the control of ECU 30.

Power generator 20 generates power using revolutions of the engine, and the power generation of power generator 20 is controlled by ECU 30. In general, power generator 20 generates power using the torque of the engine, and the power generated by the control of ECU 30 is voltage-regulated and then outputted.

ECU 30 receives information sensed by sensors disposed in the engine, a transmission, and the battery of the vehicle, and controls power generator 20 according to a power generation control algorithm which is previously built therein.

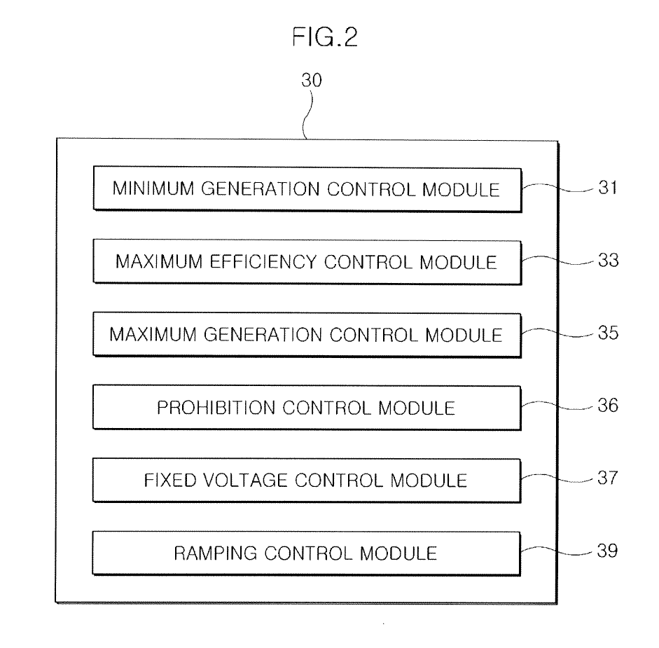

Referring to FIG. 2, ECU 30 includes a minimum generation control module 31, a maximum efficiency control module 33, a maximum generation control module 35, a prohibition control module 36, a fixed voltage control module 37, and a ramping control module 39.

Minimum generation control module 31 is a control module which is executed when an SOC value of the battery information inputted from outside is larger than a first reference value and satisfies a first logical expression below, and controls the power generator to generate a predetermined minimum amount of power.

The first logical expression may be expressed as (V=0) or (V>a and APS<b and release of direct connection of engine and transmission). Here, V represents a vehicle velocity of the driving information, APS represents an accelerator position value of the driving information, and a and b represent constants.

That is, minimum generation control module 31 is a control module which is executed when the vehicle is stopped or slowed down into an idle state. Minimum generation control module 31 may be executed in a region where the engine efficiency is low.

Minimum generation control module 31 sets a target voltage value for the minimum generation of the power generator using a current value, a voltage value, and a temperature value of the battery in the battery information, and controls power generator 20.

Specifically, minimum generation control module 31 controls power generator 20 by setting the target voltage value for the minimum generation of power generator 20 using the temperature value of the battery in the battery information and then changing the target voltage value using the current value and the voltage value of the battery in the battery information.

When the SOC value of the battery information is larger than a predetermined first prohibition value even though the battery information and the vehicle information satisfy the performance condition of the minimum generation control module, prohibition control module 36 may be executed to control power generator 20 to prohibit the power generation. In other words, when the SCO value of the battery is larger than the first prohibition value, the battery is prevented from being charged, which makes it possible to prevent the degradation of the battery and reduce fuel consumption caused by inefficient charging.

ECU 30 may execute prohibition control module 36 to prohibit the power generation when the SOC value is larger than the first reference value and satisfies a second logical expression below.

The second logical expression may be expressed as (V>0) or {(ΔV>c) or (ΔAPS>d)}. Here, V represents the vehicle velocity, ΔV represents a variable value of the vehicle velocity, ΔAPS represents a variable value of the accelerator position value of the driving information, and c and d represent constants.

Prohibition control module 36 may set a target voltage value for prohibition of the power generation using the temperature value of the battery in the battery information.

Maximum efficiency control module 33 controls power generator 20 such that the efficiency of power generator 20 is maintained within the maximum generation efficiency region of the efficiency map of the power generator, when the SOC value of the battery information is larger than the first reference value and satisfies a third logical expression below.

The third logical expression may be expressed as (V>0) or {(e<ΔV<f) or (g<ΔAPS<h)}. Here, V represents the vehicle velocity, ΔV represents a variable value of the vehicle velocity, ΔAPS represents a variable value of the accelerator position value of the driving information, and e, f, g, and h represent constants.

That is, maximum efficiency control module 33 is a control module which is executed in a state in which the vehicle travels at a constant velocity, and may be executed in a region where the generation efficiency is high.

Maximum efficiency control module 33 sets a target voltage value for the maximum efficiency of power generator 20 using an intake air flow rate and a revolution number of the engine in the vehicle information and the battery temperature value of the battery information, and controls power generator 20.

Specifically, maximum efficiency control module 33 controls power generator 20 by setting the target voltage value for the maximum efficiency of power generator 20 using the intake air flow rate and the revolution number of the engine in the vehicle information and then changing the target voltage value using the temperature value of the battery in the battery information.

Maximum generation control module 35 controls power generator 20 to perform the maximum generation, when the SOC value of the battery information is larger than the first reference value and satisfies a fourth logical expression below.

The fourth logical expression may be expressed as (V>a) and {(APS<b and direct connection of engine and transmission) or (fuel cut)}. Here, V represents the vehicle velocity of the driving information, APS represents the accelerator position value of the driving information, and a and b represent constants.

That is, maximum generation control module 35 is a control module which is executed when the vehicle is in a speed reduction state or fuel-cut state. The inertial energy of the vehicle in this state may be used for the power generation as much as possible.

Maximum generation control module 35 sets a target voltage value for the maximum generation of power generator 20 using the temperature value of the battery in the battery information, and controls power generator 20.

Fixed voltage control module 37 controls power generator 20 to maintain a predetermined fixed voltage, when it is determined that there is an error in the sensors of the power generator and the battery, using the vehicle information and the battery information. The fixed voltage may be decided by using the temperature value of the battery in the battery information.

Even in such an abnormal state, fixed voltage control module 37 may control power generator 20 to maintain the minimum charge for the battery, while considering the fuel efficiency.

Ramping control module 39 performs ramping control to smoothly change a voltage, in order to prevent a rapid variation in a target voltage value for controlling power generator 20.

Power generation control system 1 for a vehicle according to the exemplary embodiment of the present invention performs the maximum efficiency control considering the power generation efficiency, monitors the vehicle information and the battery information provided from outside in real time, and performs the power generation control in various modes, thereby increasing the fuel efficiency more than in the related art.

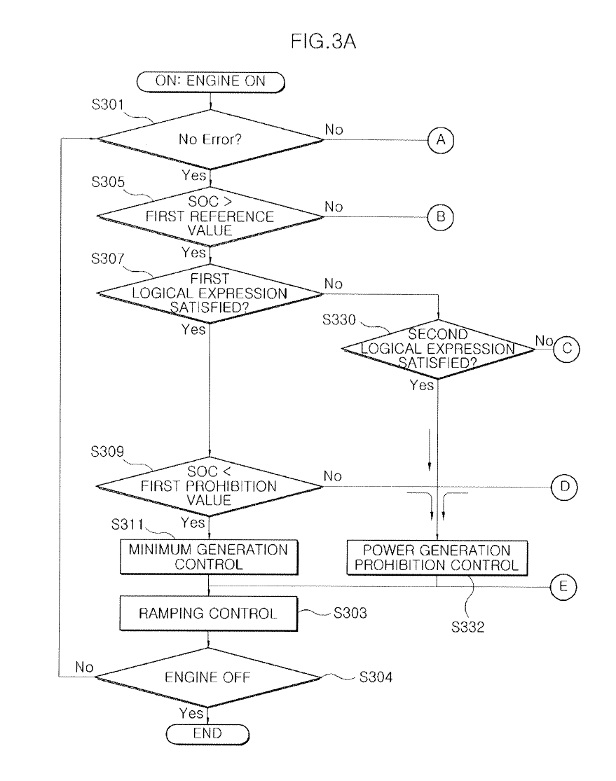

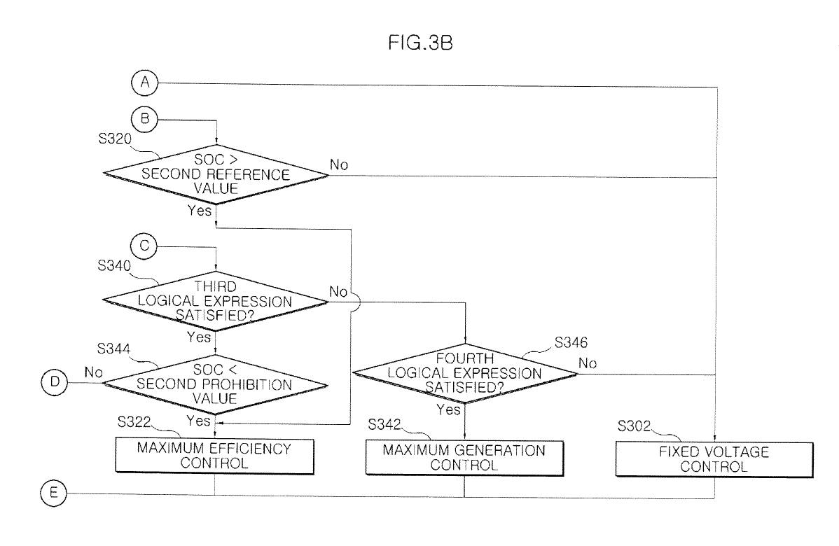

Hereinafter, referring to FIG. 3, the operation of power generation control system 1 for a vehicle according to the exemplary embodiment of the present invention will be described. Duplications of the above descriptions will be omitted herein, and the following descriptions will be focused on the control operation of ECU 30.

When the system is turned on with a start-up of the engine, ECU 30 according to the exemplary embodiment of the present invention determines whether there is an error in the sensors of power generator 20 and the battery 10 or not, using the vehicle information and the battery information (S301). When it is determined that there is no error, ECU 30 controls power generator 20 to maintain a predetermined fixed voltage (S302). That is, fixed voltage control module 37 shown in FIG. 2 is executed.

When the target voltage value for controlling power generator 20 is changed by the performance of step S302, ECU 30 performs ramping control to smoothly change the voltage, in order to prevent the target voltage value from being rapidly changed (S303). ECU 30 determines whether the engine is turned off or not (S304). When it is determined that the engine is turned off, the control process according to the exemplary embodiment of the present invention is ended. When it is determined that the engine is not turned off, the process returns to step S301.

When it is determined at the step S301 that there is an error, ECU 30 determines whether the SOC value of the battery information is larger than the first reference voltage or not (S305). When it is determined that the SOC value is larger than the first reference voltage, the ECU determines whether the SOC value satisfies the first logical expression or not, using the vehicle information (S307).

When it is determined at step S307 that the SOC value satisfies the first logical expression, ECU 30 determines whether the SOC value is smaller than the first prohibition value or not (S309). When it is determined that the SOC value is smaller than the first prohibition value, ECU 30 controls power generator 20 to perform predetermined minimum generation (S311). That is, minimum generation control module 31 shown in FIG. 2 is executed.

When the target voltage value for controlling the power generator is changed by the performance of step S311, ECU 30 performs the step S303 to prevent the target voltage value from being rapidly changed.

Meanwhile, when it is determined at step S305 that the SOC value is not larger than the first reference value, ECU 30 determines whether the SOC value is larger than the second reference value or not (S320). When it is determined that the SOC value is not larger than the second reference value, ECU 30 performs step S302.

When it is determined at step S320 that the SOC value is larger than the second reference value, ECU 30 controls power generator 20 such that the efficiency of power generator 20 is maintained within the maximum generation efficiency region of the efficiency map of power generator 20 (S322). That is, maximum efficiency control module 33 shown in FIG. 2 is executed.

When it is determined at step S307 that the SOC value does not satisfy the first logical expression, ECU 30 determines whether the SOC value satisfy the second logical expression or not, using the vehicle information (S330). When it is determined that the SOC value satisfies the second logical expression, the ECU 30 controls power generator 20 to prohibit the power generation (S332). When the target voltage value is changed by the performance of step S332, ECU 30 performs step S303 to prevent the voltage from being rapidly changed.

When it is determined at step S330 that the SOC value does not satisfy the second logical expression, ECU 30 determines whether the SOC value satisfies the third logical expression or not, using the vehicle information (S340). When it is determined that the SOC value does not satisfy the third logical expression, ECU 30 controls power generator 20 to perform the maximum generation (S342) when it satisfies the fourth logical expression S346. Here, different from maximum generation control module 35 shown in FIG. 2, ECU 30 controls the power generator 20 to perform the maximum generation when the first to third logical expressions are not satisfied. When the target voltage value is changed by the performance of step S342, ECU 30 performs step S303 to prevent the voltage from being rapidly changed.

When it is determined at step S340 that the third logical expression is satisfied, ECU 30 determines whether the SOC value is smaller than the second prohibition value or not (S344). When the SOC value is not smaller than the second prohibition value, ECU 30 performs step S332 to prohibit the power generation.

When it is determined at step S344 that the SOC value is smaller than the second prohibition value, ECU 30 performs step S322 for the maximum efficiency generation control.

As such, power generation control system 1 for a vehicle according to the exemplary embodiment of the present invention may control the power generator by reflecting fuel consumption (Fuel_Energy ALT) for a power generator load, as expressed by Equation 1 below, thereby improving the fuel efficiency.

$$Fuel\_Energy \_ALT = \int \frac{A \times V}{{η}_{ALT} \times {η}_{ENG}} \cdot d t \qquad [ Equation 1 ]$$

Here, η_{ENG} represents the indicated efficiency of engine, η_{ALT} represents the power generation efficiency, and A×V represents power [W].

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof It is intended that the scope of the invention be defined by the Claims appended hereto and their equivalents.

What is claimed is:

1. A power generation control system for a vehicle, comprising:
a battery supplying power to an electric load;
a power generator supplying power to the battery and the electric load; and
an electronic control unit (ECU) controlling the power generator in real time, based on driving information inputted from outside, battery information inputted from outside, and an efficiency map of the power generator, which is predetermined by an efficiency map of an engine and built in the power generator.

2. The power generation control system as defined in claim 1, wherein the ECU includes:
a minimum generation control module controlling the power generator to perform predetermined minimum generation under performance conditions in which a state-of-charge (SOC) value of the battery information is larger than a first reference value and satisfies a first logical expression, where the first logical expression is expressed as (V=0) or (V>a and APS<b and release of direction connection of engine and transmission), the V represents a vehicle velocity of the driving information, the APS represents an accelerator position value of the driving information, and the a and b represent constants; and
a prohibition control module controlling the power generator to prohibit power generation, when the SOC value is larger than a predetermined first prohibition value even though the performance conditions of the minimum generation control module is satisfied.

3. The power generation control system as defined in claim 2, wherein the minimum generation control module is executed by setting a target voltage value for minimum generation of the power generator, using a current value, a voltage value, and a temperature value of the battery in the battery information.

4. The power generation control system as defined in claim 3, wherein the minimum generation control module is executed by setting the target voltage value for the minimum generation of the power generator using the temperature value of the battery in the battery information and then changing the target voltage value using the current value and the voltage value of the battery in the battery information.

5. The power generation control system as defined in claim 3, wherein the prohibition control module is executed by setting a target voltage value for prohibition of the power generation of the power generator using the temperature value of the battery in the battery information.

6. The power generation control system as defined in claim 1, wherein the ECU includes a prohibition control module controlling the power generator to prohibit power generation under performance conditions in which the SOC value of the battery information is larger than a first reference value and satisfies a second logical expression, where the second logical expression is expressed as (V>0) or {(ΔV>c) or (ΔAPS>d)}, the V represents a vehicle velocity, the ΔV represents a variable value of the vehicle velocity, the ΔAPS represents a variable value of an accelerator position value of the driving information, and the c and d represent constants.

7. The power generation control system as defined in claim 6, wherein the prohibition control module is executed by setting a target voltage value for prohibition of the power generation of the power generator using a temperature value of the battery in the battery information.

8. The power generation control system as defined in claim 1, wherein the ECU includes:
a maximum efficiency control module controlling the power generator such that an efficiency of the power generator is maintained within a maximum generation efficiency region of the efficiency map of the power generator, under performance conditions in which an SOC value of the battery information is larger than a first reference value and satisfies a third logical expression, where the third logical expression is expressed as (V>0) or {(e<ΔV<f) or (g<ΔAPS<h)}, the V represents a vehicle velocity, the ΔV represents a variable value of the vehicle velocity, the ΔAPS represents a variable value of an accelerator position value of the driving information, and the e, f, g, and h represent constants; and
a prohibition control module controlling the power generator to prohibit power generation, when the SOC value is smaller than a predetermined second prohibition value even though the performance condition of the maximum efficiency control module is satisfied.

9. The power generation control system as defined in claim 8, wherein the maximum efficiency control module is executed by setting a target voltage value for a maximum efficiency of the power generator using an intake air flow rate and a revolution number of an engine in the vehicle information and a battery temperature value of the battery information.

10. The power generation control system as defined in claim 9, wherein the maximum efficiency control module is executed by setting the target voltage value for the maximum efficiency of the power generator using the intake air flow rate and the revolution number of the engine in the vehicle information and then changing the target voltage value using the battery temperature value of the battery information.

11. The power generation control system as defined in claim 8, wherein the prohibition control module is executed by setting a target voltage value for prevention of the power generation of the power generator using a battery temperature value of the battery information.

12. The power generation control system as defined in claim 1, wherein the ECU includes a maximum generation control module controlling the power generator to perform a maximum generation, under performance conditions in which an SOC value of the battery information is larger than a first reference value and satisfies a fourth logical expression, where the fourth logical expression is expressed as (V>a) and {(APS<b and direct connection of an engine and a transmission) or (fuel cut)}, the V represents a vehicle velocity of the driving information, the APS represents an accelerator position value of the driving information, and the a and b represent constants.

13. The power generation control system as defined in claim 12, wherein the maximum generation control module is executed by setting a target voltage value for the maximum generation of the power generator using a battery temperature value of the battery information.

14. The power generation control system as defined in claim 1, wherein the ECU includes:
a maximum efficiency control module controlling the power generator such that an efficiency of the power generator is maintained in a maximum generation efficiency region of the efficiency map of the power generator, under a performance condition in which an SOC value of the battery information is smaller than a first reference value and larger than a second reference value; and
a fixed voltage control module controlling the power generator to maintain a predetermined fixed voltage, when the SOC value is smaller than the first reference value and is not larger than the second reference value.

15. The power generation control system as defined in claim 14, wherein the maximum efficiency control module is executed by setting a target voltage value for the maximum efficiency of the power generator using an intake air flow rate and a revolution number of the engine in the vehicle information and a battery temperature value of the battery information.

16. The power generation control system as defined in claim 15, wherein the maximum efficiency control module is executed by setting the target voltage value for the maximum efficiency of the power generator using the intake air flow rate and the revolution number of the engine in the vehicle information and then changing the target voltage value using a battery temperature value of the battery information.

17. The power generation control system as defined in claim 1, wherein the ECU includes a fixed voltage control module controlling the power generator to maintain a predetermined fixed voltage, when determining that there is an error in sensors of the power generator and the battery, using the vehicle information and the battery information.

18. The power generation control system as defined in claim 17, wherein the fixed voltage control module is executed by setting the fixed voltage using the battery temperature value of the battery information.

19. The power generation control system as defined in claim 1, wherein the ECU includes a ramping control module performing ramping control to smoothly change a voltage, in order to prevent a target voltage value from being rapidly changed when the target voltage value for controlling the power generator is changed.

20. The power generation control system as defined in claim 1, wherein the ECU includes:
a minimum generation control module controlling the power generator to perform predetermined minimum generation, under a performance condition in which an SOC value of the battery information is larger than a first reference value and satisfies a first logical expression, where the first logical expression is expressed as (V=0) or (V>a and APS<b and release of direction connection of an engine and a transmission), the V represents the vehicle velocity of the driving information, the APS represents an accelerator position value of the driving information, and the a and b represent constants;
a maximum efficiency control module controlling the power generator such that an efficiency of the power generator is maintained within a maximum generation efficiency region of the efficiency map of the power generator, under performance conditions in which the SOC value of the battery information is larger than the first reference value and satisfies a third logical expression, or controlling the power generator such that the efficiency of the power generator is maintained within the maximum generation efficiency region of the efficiency map of the power generator, and the SOC value of the battery information is smaller than the first reference value and larger than a second reference value, where the third logical expression is expressed as (V>0) or {(e<ΔV<f) or (g<ΔAPS<h)}, the V represents a vehicle velocity of the driving information, the ΔV represents a variable value of the vehicle velocity, the ΔAPS represents a variable value of an accelerator position value of the driving information, and the e, f, g, and h represent constants; and
a maximum generation control module controlling the power generator to perform the maximum generation under performance conditions in which the SOC value of the battery information is larger than the first reference value and satisfies a fourth logical expression, where the fourth logical expression is expressed as (V>a) and {(APS<b and direct connection of the engine and the transmission) or (fuel cut)}.

21. The power generation control system as defined in claim 20, wherein the ECU further includes a prohibition control module controlling the power generator to prohibit power generation, under performance conditions in which the SOC value is larger than a predetermined first prohibition value even though the performance condition of the minimum generation control module is satisfied, the SOC value is larger than a predetermined second prohibition value even though the performance conditions of the maximum efficiency control module is satisfied, or the SOC value of the battery information is larger than the first reference value and satisfies a second logical expression, where the second logical expression is expressed as (V>0) or {(ΔV>c) or (ΔAPS>d)}, the V represents a vehicle velocity of the driving information, the ΔV represents a variable value of the vehicle velocity, the ΔAPS represents a variable value of an accelerator position value in the driving information, and the c and d represent constants.

22. The power generation control system as defined in claim 20, wherein the ECU further includes a fixed voltage control module controlling the power generator to maintain a predetermined fixed voltage, when determining that there is an error in sensors of the power generator and the battery, using the vehicle information and the battery information.

23. The power generation control system as defined in claim 20, wherein the ECU further includes a ramping control module performing ramping control to smoothly change a voltage, in order to prevent the voltage from being rapidly changed when the target voltage value for controlling the power generator is changed by the minimum generation control module, the maximum efficiency control module, or the maximum generation control module.
